(19) United States
(12) Patent Application Publication
(10) Pub. No.: US 2026/0335768 A1
(43) Pub. Date: Oct. 29, 2026

(54) System and Method for Dynamic Content Generation Through Evolving Persona Datasets with Ownership Transfer Persistence

(71) Applicants: Erik Friend, Mountain View, CA (US); Michael Steven Bankston, Vallejo, CA (US)

(72) Inventors: Erik Friend, Mountain View, CA (US); Michael Steven Bankston, Vallejo, CA (US)

(21) Appl. No.: 19/445,452

(22) Filed: Jan. 9, 2026

Related U.S. Application Data
(63) Continuation-in-part of application No. 19/320,352, filed on Sep. 5, 2025.
(60) Provisional application No. 63/793,335, filed on Apr. 23, 2025.

(51) Int. Cl. A63F 13/58; G06F 21/10

(52) U.S. Cl. CPC A63F 13/58; G06F 21/108

(57) ABSTRACT

A system and method for generating adaptive content using evolving persona datasets associated with virtual assets. When ownership of a virtual asset changes, a persona dataset derived from prior owners is filtered based on current user preferences and combined with persona data of a new owner to form a weighted, context-enriched dataset supplied to a content synthesis engine. Weighting factors include ownership duration, engagement level, and behavioral similarity. A content filtering module ensures that inappropriate content from prior owners is excluded or attenuated while preserving beneficial personality traits. Session persistence enables prior interaction sessions to influence subsequent sessions. The resulting persona adapts toward the new owner's style while preserving filtered residual influence from prior owners, producing a persistent, lineage-based identity. Applications include character cards in games, virtual assistants, AI companions, and home robots.

### CROSS REFERENCE TO RELATED APPLICATIONS

This application is a continuation-in-part of U.S. non-provisional application Ser. No. 19/320,352, filed on Sep. 5, 2025, which claims the benefit of priority of U.S. provisional application Ser. No. 63/793,335, filed on Apr. 23, 2025, which are incorporated herein by reference.

### FIELD OF DISCLOSURE

This disclosure relates generally to generation of adaptive, language-based content in connection with digital systems such as gameplay environments using character cards and virtual assets, and more particularly, to a generative conversation engine that produces in-game commentary, post-session narratives, and other adaptive responses from evolving persona datasets that reflect both current and prior user influence across ownership transitions, game sessions, and platform environments.

### BACKGROUND

Interactive entertainment and digital systems may employ language models to generate language-based content. Conventional systems, however, typically generate such content using static prompts or transient user profiles that lack meaningful continuity over time. In such cases, when control or ownership of a digital entity, character, virtual asset, or other interactive component transfers to a new user, prior behavioral context is lost, causing abrupt changes in tone and personality that disrupt continuity. There is a need for a system that preserves expressive consistency while adaptively tuning to new users and evolving contexts across gameplay, ownership changes, and other interactive environments.

Furthermore, existing systems fail to maintain behavioral remnants from prior users when virtual assets change ownership. When a character card, virtual companion, or other digital entity is transferred between players, all accumulated personality traits, linguistic patterns, and behavioral characteristics developed through interactions with previous owners are typically discarded. This results in a sterile, impersonal experience for the new owner who receives an asset devoid of its experiential history. There is a need for a system that intelligently fuses datasets from multiple owners to construct a novel basis for generating continuous, unexpected content from a language model while respecting the preferences and requirements of the current owner.

Additionally, existing systems do not adequately preserve the influence of prior game sessions on subsequent interactions. When a player completes a game session and begins a new session, the narrative context, emotional resonance, and experiential knowledge from previous playthroughs are often lost or inadequately preserved. There is a need for a system that allows past playthroughs to linger on and influence future sessions, creating a richer and more personalized experience that acknowledges the full history of interaction between a user and their virtual assets.

The inclusion of any information in this background section should not be construed as an admission that such information constitutes prior art. This section may describe aspects of the subject invention and related concepts.

### SUMMARY

The following summary relates to one or more aspects or embodiments disclosed herein. It is not intended to provide a comprehensive overview of all contemplated aspects or embodiments, nor should it be construed as identifying key or essential features limiting the scope of any particular aspect or embodiment. Rather, this summary presents certain concepts in a simplified form as a prelude to the detailed description that follows.

The present invention introduces a generative conversation framework that synthesizes multiple data sources, such as user activity, entity attributes, historical persona records, and prior ownership data, to produce contextualized content that evolves organically with continued interaction. In a gaming embodiment, this includes in-game conversational dialogue and post-session narratives based on character and player behavior. More generally, the framework applies to any digital system that maintains and combines persona datasets representing past and present users to generate adaptive content or behavior. When control of a digital entity transfers to a new user, persona data derived from prior users is merged with new user data according to weighted rules based on engagement duration, interaction level, and behavioral alignment. The resulting dataset preserves a lineage of expressive or behavioral traits while adapting to the new user's tendencies, maintaining continuity of personality or tone across successive interactions.

The system further provides content filtering capabilities that allow persona datasets from previous owners to be modulated based on the preferences, settings, and requirements of the current owner. In some implementations, content that may be inappropriate for a new user based on age, preference settings, platform requirements, or other criteria may be filtered, attenuated, or excluded from the derived persona dataset while still preserving stylistic and behavioral influences that are appropriate for the current context. This controlled inheritance effect enables moments of surprise and delight when a character card or virtual asset unexpectedly echoes the mannerisms or phrasing of a prior owner, while ensuring such echoes remain within acceptable parameters for the current user.

The system additionally maintains session persistence, wherein behavioral and contextual data from prior game sessions lingers and influences subsequent sessions. Past playthroughs contribute to an evolving session history dataset that shapes future interactions, ensuring that the experiential knowledge, narrative arcs, and emotional resonance from previous sessions remain available to enrich future gameplay. This session persistence operates in conjunction with ownership transfer mechanisms to create a multi-layered persona that reflects both the longitudinal history of the virtual asset across multiple owners and the session-by-session evolution of interaction patterns within each ownership period.

According to one aspect of this disclosure, a method for generating adaptive conversational content in a digital environment includes receiving a first persona dataset associated with one or more previous owners or users of a virtual asset; receiving a second persona dataset associated with a current owner or user of the virtual asset; applying a content filter to the first persona dataset based on preferences or requirements of the current owner or user; combining the filtered first persona dataset and the second persona dataset to generate a derived persona dataset associated with the current owner; and supplying the derived persona dataset to a conversation synthesis engine configured to generate language output that reflects both the current owner and filtered prior ownership influence.

In some examples, the first persona dataset and the second persona dataset are combined according to a weighting function based on at least one of ownership duration, engagement level, and behavioral alignment.

In some examples, the weighting function applies higher weighting to more recent interactions and lower weighting to older interactions to adapt the derived persona dataset toward the current owner over time, while maintaining an asymptotic limit that preserves residual influence from prior owners.

In some examples, the content filter excludes or attenuates content based on at least one of age-appropriateness settings, profanity filters, tone aggressiveness limits, prohibited content lists, brand guidelines, and platform regulations.

In some examples, the method further includes receiving a session history dataset representing behavioral and contextual data from one or more prior sessions; and incorporating the session history dataset into the derived persona dataset to enable prior session influence on subsequent sessions.

In some examples, the virtual asset includes at least one of a character card, a digital companion, a non-player character, a weapon, a tool, a location, a virtual pet, a robot persona, a virtual assistant configuration, or a social artificial intelligence companion.

According to another aspect of this disclosure, a system for managing evolving persona datasets across ownership transitions includes a plurality of computing devices networked via a communication network; a database system storing virtual asset data including persona datasets associated with prior owners; a content filtering module configured to filter persona data based on current user preferences; a persona synthesis module configured to combine filtered prior owner persona data with current owner persona data to generate a derived persona dataset; and a conversation synthesis engine configured to generate adaptive language content based on the derived persona dataset.

Additional aspects of this disclosure are described in greater detail below and are illustrated in the accompanying drawing figures.

### BRIEF DESCRIPTION OF THE DRAWINGS

The following description and accompanying drawings illustrate various features and advantages of this disclosure. The drawings are not necessarily to scale, as emphasis is placed on illustrating the principles of the disclosure. Like reference characters may be used to indicate the same components across different figures and views. The drawings provide illustrative examples and should not be construed as limiting the scope of this disclosure.

FIG. 1 is a diagram illustrating formation of a composite card unit comprising a single host card from a host deck paired with a single rider card from a distinct rider deck, in accordance with aspects of this disclosure.

FIG. 2 is a diagram of an exemplary composite card deck formed from a plurality of composite card units, in accordance with aspects of this disclosure.

FIG. 3 is a diagram illustrating a composite card unit comprising a host card and an overlaid rider card, in accordance with aspects of this disclosure.

FIG. 4 is a flow diagram illustrating a method for forming composite card units, in accordance with aspects of this disclosure.

FIG. 5 is a block diagram illustrating a generative conversation system including a conversation synthesis engine that generates in-game commentary and post-session narrative content based on multiple input datasets and adaptive tuning feedback, in accordance with aspects of this disclosure.

FIG. 6 is a flow diagram of a method for combining persona data from previous owners with persona data of a new owner to form a derived persona dataset, including content filtering based on current user preferences, in accordance with aspects of this disclosure.

FIG. 7 is a block diagram illustrating session persistence and cross-session influence in the generative conversation system, in accordance with aspects of this disclosure.

FIG. 8 is a block diagram of an exemplary computer system and network architecture for implementing the system and method of this disclosure.

FIG. 9 is a block diagram illustrating components of an exemplary computing device for use in the system of this disclosure.

FIG. 10 illustrates the prompt mapping schema for the system.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature may also be used, to the extent possible, in combination with and/or in the context of other particular aspects and embodiments of the invention, and in the invention generally.

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skills in the art to which this disclosure pertains.

This disclosure provides a system and method for generating adaptive content based on evolving persona datasets associated with virtual assets. As used herein, the term “virtual asset” refers broadly to any digital entity capable of having an associated persona dataset that evolves through interaction with users. Virtual assets may include, without limitation, character cards in card-based games, digital companions, virtual pets, non-player characters (NPCs), robot personas, virtual assistant configurations, social artificial intelligence (AI) companions, and other interactive digital entities. While certain embodiments are described with reference to character cards in a gaming context, the teachings of this disclosure apply generally to any virtual asset capable of ownership transfer and persona evolution.

In a card-based implementation, the system provides a method for pairing a host card from a host deck with a rider card from a rider deck to form a composite card unit. The rider cards are distinct from the host cards in at least design, content, or function. The composite card units formed from the host and rider cards are sometimes referred to herein as “battle pairs”. Each battle pair has a unique identity derived from the attributes of its constituent cards. Battle pairs are generated at the beginning of each session and are then combined to form a new composite card deck, referred to herein as a “battle deck”, which consists entirely of battle pairs.

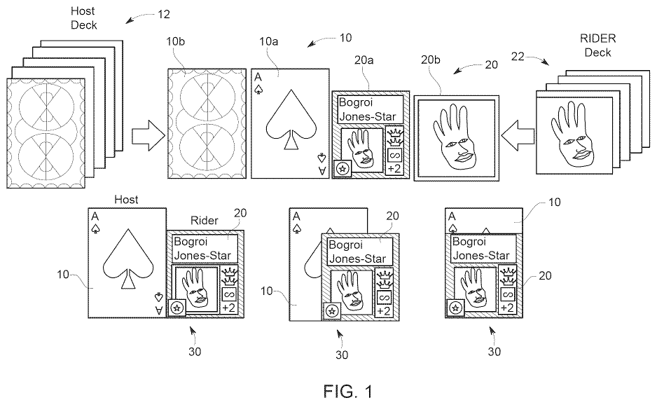

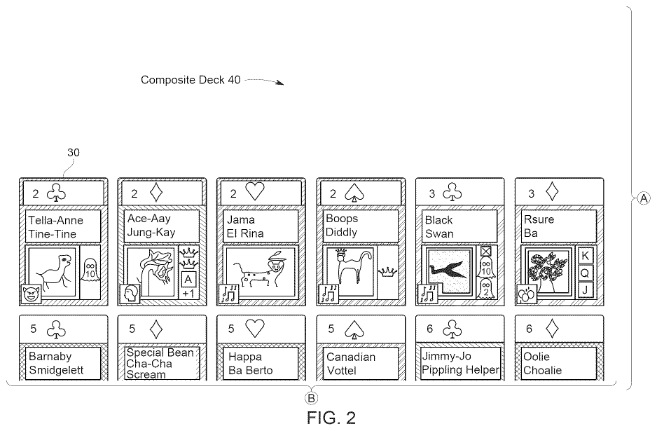

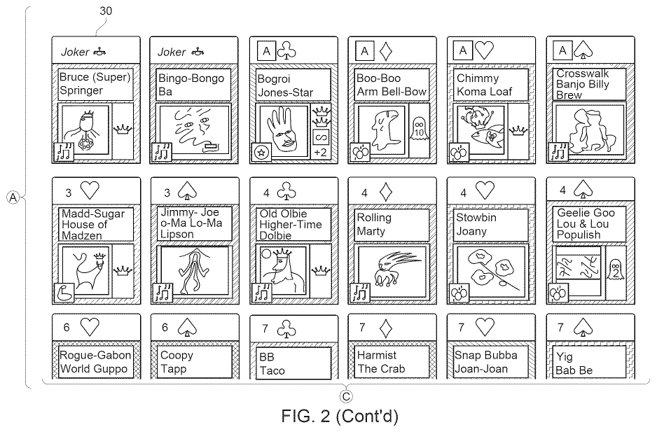

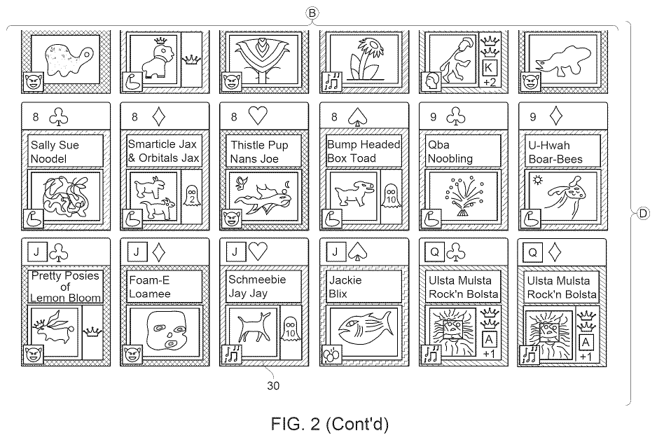

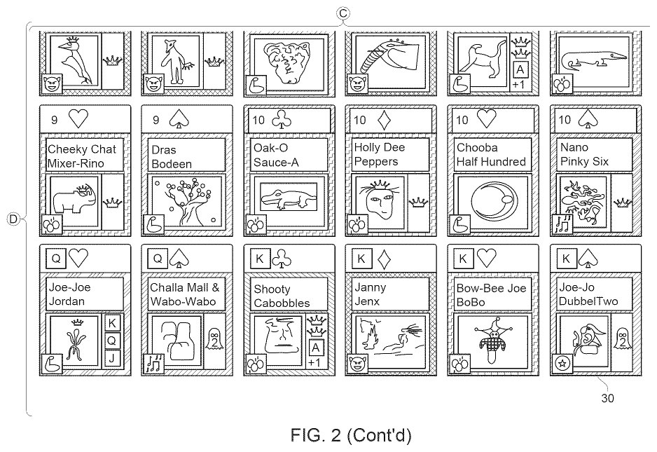

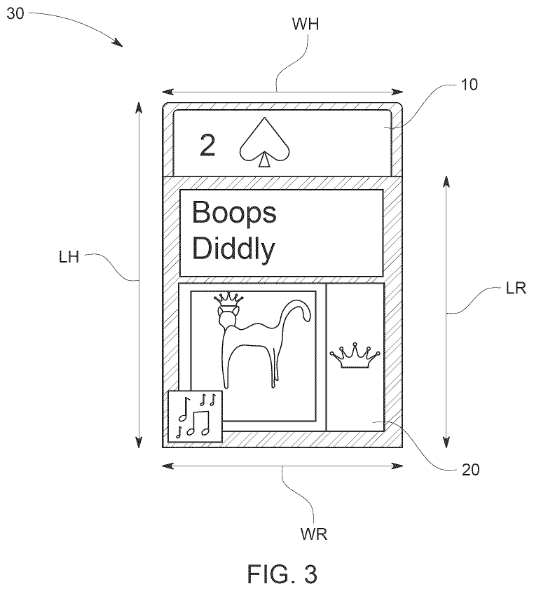

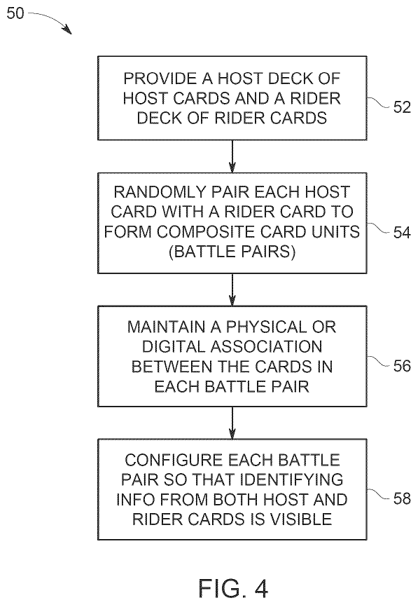

FIG. 1 is a diagram illustrating the formation of a composite card unit 30, referred to herein as a battle pair, comprising a single host card 10 from a host deck 12 paired with a single rider card 20 from a distinct rider deck 22, in accordance with aspects of this disclosure. The pairing of cards 10 and 20 from these two distinct decks 12 and 22 establishes a composite card unit 30 that integrates attributes from both constituent cards while maintaining a unique identity as a battle pair for the duration of a session.

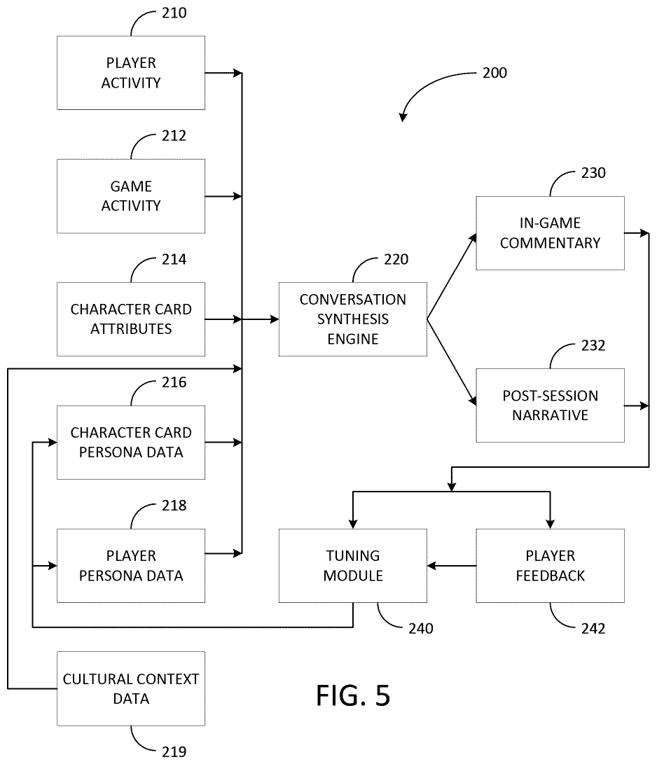

A digital platform implementation includes generative conversation engine 200 (FIG. 5) configured to generate both in-game commentary and post-session summaries or narratives derived from player and game activity, virtual asset attributes and persona data, player persona data, cultural context data, and session history data. The in-game commentary component presents multiple concurrent points of view including those of the player and one or more interacting virtual assets such that the resulting exchange resembles a lively, natural conversation among distinct participants, with individual voices entering and exiting the dialogue organically, as one would experience a card game played among friends. The post-session narrative component transforms the events of a recent play session into a personalized story centered on the player and the participating virtual assets, analogous to a horoscope or tarot reading but grounded in the actual gameplay experience. Engine 200 maintains continuity of tone and identity across both content types, ensuring that the same persona “voice” remains coherent in spontaneous, real-time banter as well as in reflective narrative form.

As illustrated in FIG. 5, generative conversation engine 200 utilizes multiple input streams to generate both the in-game commentary and the post-session summary narratives. These input streams may include, without limitation, player activity 210, game activity 212, virtual asset attributes 214, virtual asset persona data 216, player persona data 218, cultural context data 219, and session history data 221. Each of these input streams contributes a distinct dimension of context to the conversation generation process, enabling engine 200 to produce dialogue and narrative content that reflects real gameplay events as well as the evolving personality traits of both the player and the engaged virtual assets.

Player activity 210 encompasses player-originated inputs and interactions occurring within the game and platform environment. This may include player questions, commands, and other activity reflecting ongoing decisions and actions during a game session. Player activity 210 may further encompass virtual asset selection, use, and resulting outcomes, as well as player-generated comments or reactions to conversations produced by engine 200. Player activity 210 may take the form of control inputs, text entries, spoken dialogue, and other interface signals received in real time.

Game activity 212 represents events and activity occurring within the game or active session, independent of direct player input. This input stream includes data describing the mechanical aspects of gameplay, such as rules, scoring, timing, moves, and outcomes. Game activity 212 thereby provides the objective framework within which player actions are interpreted, ensuring that the generative conversation engine 200 can reference concrete in-game events when constructing commentary or narrative content.

Virtual asset attributes 214 define objective, rule-based, and quantifiable parameters that govern how each virtual asset performs within the system framework. Each distinct virtual asset possesses its own corresponding set of attributes 214, which determine the capabilities and influence of the asset during interaction. Attributes 214 may include, without limitation, power level, intelligence, agility, skill ratings, special abilities, classification level, and other parameters relevant to the particular type of virtual asset. Thus, attributes 214 establish what a particular virtual asset can do within the context of a session—its strengths, limitations, and interactive potential. When provided to generative conversation engine 200, attributes 214 enable generated dialogue to maintain consistency with the defined role and capability of a particular virtual asset.

Virtual asset persona data 216 defines long-term behavioral and expressive characteristics of a given virtual asset. In addition to its distinct attributes 214, each virtual asset possesses a unique persona that governs how it communicates, reacts, and “feels” within conversations generated by engine 200. Over time, each virtual asset accumulates persona data 216 that manifests through generated language including tone, linguistic style, humor tendencies, empathy level, and narrative voice. Persona data 216 may include embedded data vectors that encode behavioral traits such as sarcasm, confidence, optimism, restraint, and the like, along with long-term parameters representing accumulated experience, history, and prior ownership or any type of user affiliation influence (dialogue, interaction, fights, relationships). Whereas attributes 214 define the functional abilities of a virtual asset within the system framework, persona data 216 defines its expressive and emotional personality, determining how it speaks, reacts, and evolves through repeated interaction with users and other virtual assets.

The platform supports dynamic ownership transfer of virtual assets among users. When ownership changes, the expressive and behavioral history embodied in virtual asset persona data 216 persists, but future interactions begin to reflect the influence of the new owner. Each virtual asset thus carries a form of evolving personality shaped by the cumulative interactions of its successive owners. This approach treats the virtual asset's data as a universal, self-evolving system that adapts and learns from interactions across different owners while maintaining continuity of identity.

It should be appreciated that the terminology for owner applies to any type of user that has been affiliated or partially affiliated with a virtual asset such as a non-playable character having a relationship with a first user, then later a second user whether it is in the same game or physical disc or carries over to a different game where remnants of interactions with the first user may persist in some form. This may also carry over to subsequent playthroughs whereby even the same user may encounter constant chances with non-playable characters or other assets where they remember in some form the previous playthroughs and interactions with the first user which carry over.

Early, formative interactions tend to imprint the strongest and most enduring influence, establishing the virtual asset's core behavioral tendencies. Later interactions introduce adaptive refinements, while recent experiences exert the most immediate and pronounced effects, gradually mellowing or blending the influence of past owners. This temporal weighting, modeled after the way human personality evolves under environmental and social influence, enables each virtual asset to develop a nuanced and persistent identity that retains traces of its lineage while continuously adapting to its current owner's expressive style and interaction patterns.

By way of analogy, the personality evolution of a virtual asset may be understood by reference to human experience. Just as an 80-year-old individual who lived in one city for 79 years and then relocated to another city may gradually adopt vocabulary and mannerisms of the new location while never fully erasing the influence of the original environment, a virtual asset with extensive historical persona data may evolve slowly toward the style of a new owner while permanently retaining characteristic elements from prior owners. A newly created virtual asset with only one owner will have a persona fully aligned to that one owner, whereas a virtual asset with multiple prior owners will exhibit a blended personality reflecting its entire ownership lineage.

When ownership of a virtual asset changes, virtual asset persona data 216 associated with prior ownership is merged with player persona data 218 of the new owner to generate a combined, contextually enriched dataset. This composite dataset serves as the foundation for initializing and tuning conversational synthesis engine 220 for the new owner, ensuring continuity of virtual asset personality while introducing adaptive personalization. The combination process weights historical and current data based on factors such as duration of ownership, frequency of engagement, and behavioral alignment between the former and current owners. The resulting derived dataset is dynamically synthesized from overlapping, correlated, or complementary features across the source datasets, producing an enriched representation that balances legacy traits with current player identity. This allows engine 220 to produce dialogue that feels both familiar and freshly adaptive, capturing subtle stylistic influences from prior owners while remaining aligned with the expressive tone and preferences of the current owner.

The fused dataset is not a simple aggregation of prior data, but a context-aware synthesis that preserves key identity markers from earlier ownership while respecting brand, content, and tone requirements of the current platform environment and the preferences of the current user. The system includes a content filtering module 250 configured to filter, attenuate, or exclude persona data elements that may be inappropriate for the current user based on various criteria.

Content filtering module 250 applies filtering rules based on at least one of the following criteria: age-appropriateness settings associated with the current user; profanity filters and language intensity thresholds; tone aggressiveness limits specifying acceptable levels of assertive, confrontational, or provocative language; prohibited content lists specifying topics, themes, or expressions that should be excluded; brand guidelines defining acceptable content for the platform or application; and regulatory requirements applicable to the platform or jurisdiction based on location or time.

The filtering process operates on virtual asset persona data 216 prior to combination with player persona data 218, such that elements from prior owners that conflict with the current user's preferences or requirements are filtered before the derived dataset is generated. In some implementations, filtering may operate continuously on the derived persona dataset, dynamically adjusting the expression of prior owner influence based on context-specific factors such as the nature of the current interaction, the presence of other users, or platform-specific requirements.

Within the constraints established by content filtering module 250, stylistic and linguistic influences from previous owners remain partially embedded within the fused virtual asset persona dataset. This controlled inheritance effect drives moments of surprise and delight, such as when a virtual asset unexpectedly echoes the mannerisms or phrasing of a prior owner in a manner that is appropriate for the current context. The filtering ensures that such echoes remain within acceptable parameters while still providing the beneficial effects of personality continuity and lineage-based character development.

The system is personalized to the current owner, but drives “surprise and delight moments” when a virtual asset produces unexpected discourse that was “learned” from a past owner. These moments occur when behavioral patterns, linguistic quirks, or expressive tendencies from prior owners emerge organically in generated content, creating the impression that the virtual asset has a genuine history and personality depth that transcends its current ownership. Content filtering ensures that such emergent behaviors remain appropriate for the current user while preserving their capacity to create memorable and engaging interactions.

The system maintains session history data 221 representing behavioral and contextual data from prior game sessions or interaction sessions. Session history data 221 enables past playthroughs to linger on and influence subsequent sessions, creating continuity of experience that extends beyond individual interaction instances. This session persistence operates independently of and in conjunction with ownership transfer mechanisms, providing a second dimension of temporal continuity in the generative conversation system.

Session history data 221 may include, without limitation, narrative events and outcomes from prior sessions; emotional states and relationship dynamics established during previous interactions; learned preferences and behavioral patterns observed within specific sessions; contextual markers indicating significant moments, achievements, or turning points; and temporal metadata indicating session timing, duration, and sequence.

Conversation synthesis engine 220 incorporates session history data 221 as an additional input stream when generating in-game commentary 230 and post-session narrative 232. This enables the generated content to reference, build upon, or contrast with events and experiences from prior sessions. For example, a virtual asset may comment on how a current game situation resembles or differs from a similar situation in a previous session, or may express emotions influenced by unresolved narrative threads from earlier interactions.

The session persistence mechanism applies weighting functions similar to those used for ownership transfer; wherein more recent sessions exert stronger influence on current interactions while older sessions contribute progressively attenuated but persistent influence. The weighting function may consider factors such as session recency, session significance (based on notable events or achievements), and thematic relevance to the current interaction context.

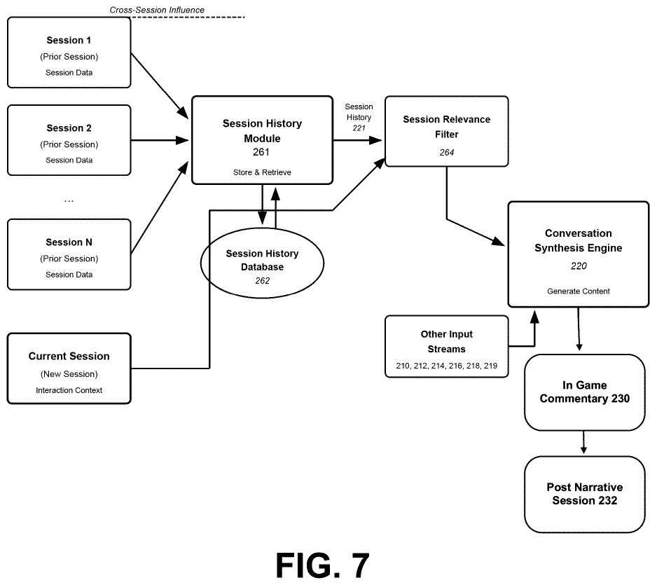

FIG. 7 illustrates session persistence and cross-session influence in the generative conversation system. Session history module 261 receives session data upon completion of each interaction session and stores the data in session history database 262. When a new session begins, session history module 261 retrieves relevant session history data 221 and provides it to conversation synthesis engine 220 along with other input streams. A session relevance filter 264 may determine which elements of session history are most relevant to the current interaction context, ensuring that session persistence enhances rather than overwhelms the current experience.

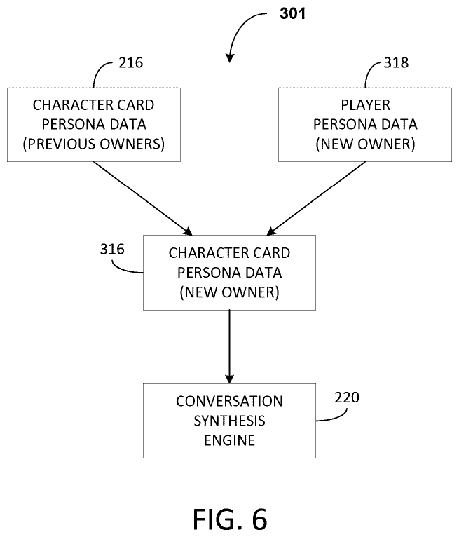

FIG. 6 illustrates a method 301 for combining multiple datasets associated with prior and current ownership of a virtual asset to produce a derived dataset that governs conversational behavior following ownership transfer. In the example of FIG. 6, ownership of a virtual asset is transferred from a current owner to a new owner. Virtual asset persona dataset 216, which embodies the expressive and behavioral characteristics of all of its previous owners (including the current owner), is associated with the virtual asset. The new (acquiring) owner has their own player persona dataset 318.

The system receives virtual asset persona dataset 216 representing prior owner characteristics. The system the receives player persona dataset 318 representing current owner characteristics. The content filtering module 250 applies content filters to virtual asset persona dataset 216 based on preferences, settings, and requirements associated with the new owner. The filtering may exclude, attenuate, or modify persona data elements that conflict with the new owner's content preferences.

The filtered virtual asset persona dataset is combined with player persona dataset 318 to generate derived virtual asset persona dataset 316. The combination process applies a weighting function that governs how strongly prior owner and current owner influences are represented within the newly synthesized dataset. The weighting function considers factors such as duration of ownership, level of engagement, and significance of interactions associated with each previous owner. Earlier, formative engagements typically impart greater long-term influence, while more recent interactions are weighted heavily for near-term responsiveness.

The derived virtual asset persona dataset 316 is stored in database 350 for use in subsequent content generation. In step 312, derived dataset 316 is provided to conversation synthesis engine 220, which uses it together with other input streams to generate language content that exhibits continuity of personality across ownership transitions while respecting the content preferences of the current owner.

The weighting function may exhibit asymptotic adaptation behavior, in which the influence of the new owner increases over time but never fully replaces the historical traits of prior owners. Thus, a virtual asset with extensive historical data within virtual asset persona dataset 216 may evolve slowly toward the persona of the new owner, whereas a newly created or single-owner virtual asset will align almost entirely with the persona dataset of its current owner. The derived virtual asset persona dataset 316 therefore represents a snapshot in time of the virtual asset's evolving personality, continuously updated through interaction but always retaining traces of its lineage.

In one illustrative embodiment, a virtual magical weapon such as a sword, staff, or firearm in a role-playing game maintains a training history dataset that evolves based on the combat styles, techniques, and preferences of its successive owners. When a player acquires the weapon, the weapon's persona dataset includes behavioral traits and combat tendencies developed through interactions with all prior owners.

For example, consider a legendary sword that has passed through multiple owners over time. The first owner was an aggressive, offense-focused warrior who frequently used charging attacks and power strikes. Through extended gameplay, the sword's persona dataset accumulated weighted parameters reflecting this aggressive combat style, including high values for attack speed preference, critical strike tendency, and forward momentum techniques.

The second owner was a defensive, tactical fighter who favored parrying, counterattacks, and patience. During this ownership period, the sword's persona dataset was updated to incorporate defensive timing patterns, counterattack recognition, and measured strike sequences. However, due to the asymptotic weighting function, the aggressive traits from the first owner were attenuated but not eliminated, resulting in a blended combat personality.

When a third owner acquires the sword, the derived persona dataset supplied to the content synthesis engine reflects both prior owners' influences.

Certain core traits established during formative early ownership remain substantially persistent. For instance, if the first owner extensively trained the weapon in fire-elemental techniques, this elemental affinity becomes a deeply embedded characteristic that persists across all subsequent ownership transfers, even as surface-level combat style preferences adapt to new owners. The weighting function ensures that such foundational traits, established through prolonged early interaction, maintain significant influence regardless of subsequent ownership changes.

Conversely, more recent and superficial preferences adapt more readily. If the current owner prefers one-handed grip techniques over the two-handed style used by prior owners, the weapon's generated behaviors and commentary will relatively quickly shift to reflect one-handed combat patterns while still retaining the underlying elemental affinity and residual stylistic echoes from its lineage.

In one or more non-limiting embodiments, content filtering module 250 may also ensure that any combat behaviors or weapon commentary inappropriate for the current user are filtered from the derived persona dataset. For example, if the weapon accumulated aggressive taunting behaviors from a prior adult owner, and the current owner is a minor with age-appropriate content settings enabled, such behaviors are attenuated or excluded while preserving appropriate combat style influences. This creates a weapon with genuine history and personality depth, providing a virtual asset that feels authentically weathered by experience, carrying forward the accumulated wisdom and muscle memory of all who wielded it before, while still adapting to serve its current master.

The techniques described herein are not limited to gameplay or character cards but may be applied more broadly to any digital system that generates adaptive language or behavior based on evolving user interactions. In such implementations, a first persona dataset may represent behavioral or expressive characteristics derived from one or more prior users of the digital system, and a second persona dataset may represent behavioral or expressive characteristics of a current user of the digital system. The digital system may then combine the first persona dataset and the second persona dataset, with appropriate content filtering, to generate an adaptive persona dataset. The adaptive persona dataset is subsequently used to govern generation of adaptive content or behavior for the current user, reflecting the influence of both prior users and the current user.

Exemplary digital systems to which the teachings of this disclosure may be applied include, without limitation: a gaming platform that generates in-game commentary and post-session narrative for players, wherein character cards or other virtual assets maintain personality continuity across ownership changes; a virtual assistant that adapts conversational tone, recommendations, or guidance to a specific active user while retaining beneficial learned behaviors from prior users; a social artificial intelligence (AI) companion that maintains an evolving expressive style across multiple human users while presenting individualized behavior to a currently engaged user; and a robot, such as a home or family robot, that synthesizes shared household history while tailoring spoken responses, demeanor, and behavioral actions to the individual who is currently interacting with it.

In a home robot implementation, the robot has to synthesize family learning content but also offer a specific speaking style to each individual, from a grandparent to a young child. At the moment of engagement, the robot is responsive to a specific member of the family owning the engagement. The generated language is mostly tuned by the engagement owner; however, the tuning of the robot accesses key global family data for the best user family robot experience and safety. Content filtering ensures that content appropriate for adult family members does not inappropriately influence interactions with children.

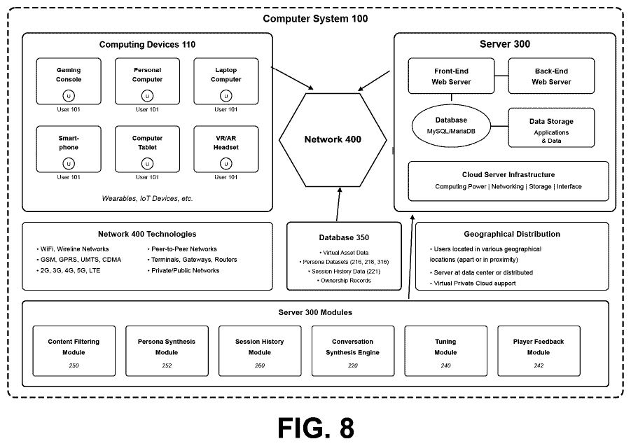

FIG. 8 is a block diagram of an exemplary computer system 100 and network architecture for implementing the system and method of this disclosure. Computer system 100 may include a plurality of computing devices 110. Computing devices 110 may be any number of devices capable of executing the methods and systems described herein and may include, for example, gaming consoles, personal computers, desktop computers, laptop computers, computer tablets, smartphones, wearable computing devices, virtual reality headsets, augmented reality devices, or other computing devices under the philosophy of the internet of things.

Computing devices 110 and users 101 may be located in various geographical locations that are either located apart or are located in proximity to each other. As used herein, the terms user and player may be used interchangeably. Computing devices 110 may include a processor, for example a central processing unit based on x86 architecture as designed by Intel or AMD, or a system-on-a-chip as designed by ARM. The processor may be communicatively coupled to auxiliary devices or modules of computing devices 110 using a bus or other coupling. Optionally, the processor and some or all of its coupled auxiliary devices or modules may be housed within or coupled to a housing of the computing devices 110.

In some embodiments, computing devices 110 may be in communication with one or more servers, such as server 300, via one or more networks such as network 400. Server 300 may be located at a data center or any other location suitable for providing service to network 400, whereby server 300 may be in one central location or in many different locations in multiple arrangements. Server 300 may include a database server such as MySQL or MariaDB server. Server 300 may have an attached data storage system storing software applications and data.

Server 300 may include a front-end web server that is coupled to computing devices 110 and other devices via a network such as the Internet. The front-end web server may provide services including login services, user authentication, and session management. Server 300 may include a back-end web server that is coupled to computing devices 110 via the Internet. The back-end web server may be on the same network or the same machine as a database server. The database server may process and store user information, virtual asset information, persona datasets, session history data, and other data associated with the system.

Server 300 may have cloud server infrastructure which may be the collection of hardware and software elements needed to enable cloud computing. Cloud server infrastructure may include computing power, networking, storage, and interface for user access. A virtual private cloud is an on-demand configurable pool of shared computing resources allocated within a public cloud environment, providing a certain level of isolation between different organizations and users.

In one or more non-limiting embodiments, network 400 may include a local area network (LAN), such as a company intranet, a metropolitan area network (MAN), or a wide area network (WAN), such as the Internet or World Wide Web. Network 400 may be a private network or a public network, or a combination thereof. Network 400 may be any type of network known in the art, including a telecommunications network, a wireless network (including Wi-Fi), and a wireline network. Network 400 may include mobile telephone networks utilizing any protocol or protocols used to communicate among mobile digital computing devices, such as GSM, GPRS, UMTS, AMPS, TDMA, or CDMA. In alternative embodiments, computing devices 110 may act as standalone devices or may operate as peer machines in a peer-to-peer or distributed network environment.

Network 400 may further include a system of terminals, gateways, and routers. Network 400 may employ one or more cellular access technologies including 2nd (2G), 3rd (3G), 4th (4G), 5th (5G), LTE, Global System for Mobile communication (GSM), General Packet Radio Services (GPRS), Enhanced Data GSM Environment (EDGE), and other access technologies that may provide for broader coverage between computing devices 110 if for instance they are in a remote location not accessible by other networks.

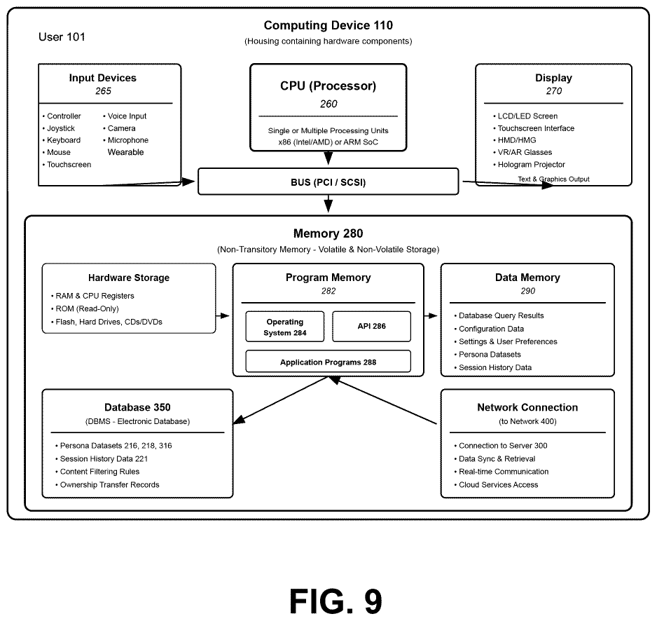

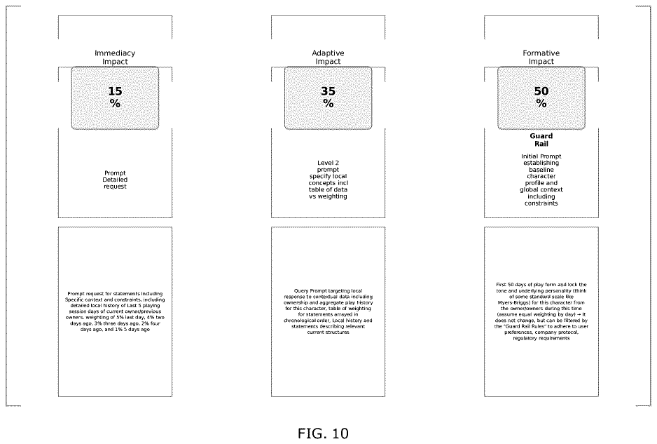

FIG. 9 is a block diagram showing various components of a computing device 110. Computing device 110 may include a housing for containing one or more hardware components. Computing device 110 may include one or more input devices such as input devices 265 that provide input to a CPU (processor) such as CPU 260 of actions related to a user 101. Input devices 265 may be implemented as a controller, a joystick, a keyboard, a touchscreen, a mouse, via voice activation, a wearable input device, a camera, a trackball, or a microphone.

CPU 260 may be a single processing unit or multiple processing units in a device or distributed across multiple devices. CPU 260 may be coupled to other hardware devices, such as one or more memory devices, with the use of a bus, such as a PCI bus or SCSI bus. CPU 260 may communicate with a hardware controller for devices, such as for a display 270. Display 270 may be used to display text and graphics. In some examples, display 270 provides graphical and textual visual feedback to a user.

In one or more embodiments, display 270 may include an input device 265 as part of display 270, such as when input device 265 is a touchscreen or is equipped with an eye direction monitoring system. In some implementations, display 270 is separate from input device 265. Examples of display 270 include but are not limited to: an LCD display screen or an LED display screen. Display 270 may also include a touch screen interface operable to detect and receive touch input such as a tap or a swiping gesture. Display 270 may be a binocular head mounted display (HMD), head mounted goggles (HMG), an augmented reality device, virtual reality glasses, a hologram projector, or another form of device that is connectable to the computing device whereby users may view a virtual environment through the display.

CPU 260 may have access to a memory such as memory 280. Memory 280 may include one or more of various hardware devices for volatile and non-volatile storage and may include both read-only and writable memory. For example, memory 280 may include random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory 280 may be a non-transitory memory.

Memory 280 may include program memory such as program memory 282 capable of storing programs and software, including an operating system, such as operating system 284. Memory 280 may further include an application programming interface (API), such as API 286, and other computerized programs or application programs such as application programs 288. Memory 280 may also include data memory such as data memory 290 that may include database query results, configuration data, settings, user options, user preferences, persona datasets, session history data, or other types of data which may be provided to program memory 282 or any element of computing device 110.

Database 350 represents a series of data that is managed by a database management system, also called electronic database, and is structured to facilitate the storage, retrieval, modification, and deletion of data in conjunction with various data-processing operations. Database 350 may store virtual asset data including persona datasets 216, player persona datasets 218, derived persona datasets 316, session history data 221, content filtering rules, and ownership transfer records. The database is an organized collection of data, generally stored and accessed electronically from various components connected over network 400.

Server 300 may have a number of modules that provide various functions related to the system. Modules may be in the form of software or computer programs that interact with the operating system of server 300 whereby data collected in database 350 as instruction-based expressions of components and processes may be processed by one or more processors within server 300 or another component of computing devices 110 as well as in conjunction with execution of one or more other computer programs. Modules may be configured to receive commands or requests from computing devices 110, server 300, and outside connected devices over network 400.

The modules of server 300 may include content filtering module 250, persona synthesis module 252, session history module 261, conversation synthesis engine 220, tuning module 240, and player feedback module 242. Content filtering module 250 applies filtering rules to persona data based on current user preferences and platform requirements. Persona synthesis module 252 combines filtered prior owner persona data with current owner persona data according to weighting functions to generate derived persona datasets. Session history module 261 manages storage and retrieval of session history data and determines relevance of historical session data to current interactions. Conversation synthesis engine 220 receives multiple input streams and generates in-game commentary and post-session narrative content. Tuning module 240 applies adaptive learning algorithms to adjust persona datasets based on observed outcomes. Player feedback module 242 monitors and aggregates player reactions to generated content.

Conversational synthesis engine 220 receives and processes the multiple input streams described above to generate coherent, contextually relevant conversational output. In operation, engine 220 encodes each input including player activity 210, game activity 212, virtual asset attributes 214, virtual asset persona data 216, player persona data 218, cultural context data 219, and session history data 221 into feature representations or embedding vectors that capture linguistic, behavioral, and gameplay context. These representations may be combined into a conditioning sequence supplied to a trained language generation architecture, such as a transformer-based neural network, which applies learned probabilistic relationships between tokens to synthesize natural language text. Engine 220 integrates weighting functions and filters to ensure that information from each input stream contributes proportionally to the generated content, producing dialogue and narrative output that remain consistent with gameplay events, player behavior, virtual asset personalities, cultural influences, and session history.

While certain embodiments are described herein, they are provided by way of example only and do not limit the scope of this disclosure. Various modifications, substitutions, and omissions may be made without departing from the spirit and scope of the invention. The methods and processes described herein are not limited to any particular sequence and may be used independently or in combination. Steps may be omitted, reordered, or added in different implementations. No aspect of this description should be interpreted as requiring any specific feature, component, or step as essential or indispensable. Many variations, modifications, and enhancements are possible, all of which fall within the scope of the invention as defined by the following claims.

1. A method for generating adaptive content in a digital environment, comprising: receiving a first persona dataset associated with one or more previous users associated with a virtual asset, wherein the first persona dataset is derived from prior interactions of the one or more previous users with the virtual asset; receiving, in response to a transfer of the virtual asset from the one or more previous users to a current user, a second persona dataset associated with the current user associated with the virtual asset, wherein the current user is distinct from the one or more previous users; applying a content filter to the first persona dataset based on at least one preference or requirement of the current user; combining the filtered first persona dataset and the second persona dataset to generate a derived persona dataset associated with the current user, wherein the derived persona dataset persists with the virtual asset and preserves residual influence of the one or more previous users; and supplying the derived persona dataset to a content synthesis engine configured to generate output that reflects both the current user and filtered one or more previous user influence.

2. The method of claim 1, wherein the first persona dataset and the second persona dataset are combined according to a weighting function based on at least one of association duration, engagement level, and behavioral alignment.

3. The method of claim 2, wherein the weighting function applies higher weighting to more recent interactions and lower weighting to older interactions to adapt the derived persona dataset toward the current user over time, while maintaining an asymptotic limit that preserves residual influence from the one or more previous users.

4. The method of claim 1, wherein the content filter excludes or attenuates content based on at least one of age-appropriateness settings, profanity filters, tone aggressiveness limits, prohibited content lists, brand guidelines, and platform regulations.

5. The method of claim 1, further comprising: receiving a session history dataset representing behavioral and contextual data from one or more prior sessions; and incorporating the session history dataset into the derived persona dataset to enable prior session influence on subsequent sessions.

6. The method of claim 5, wherein the session history dataset includes at least one of narrative events from the one or more prior sessions, emotional states established during previous interactions, learned preferences observed within specific sessions, and contextual markers indicating significant moments or achievements.

7. The method of claim 1, wherein the virtual asset comprises at least one of a character card, a digital companion, a non-player character, a virtual pet, a robot persona, a virtual assistant configuration, or a social artificial intelligence companion.

8. The method of claim 1, wherein the output comprises at least one of in-game commentary, post-session narrative content, spoken dialogue, and behavioral responses.

9. The method of claim 1, wherein the content synthesis engine receives additional input streams comprising at least one of player activity, game activity, virtual asset attributes, and cultural context data.

10. The method of claim 1, wherein the derived persona dataset is dynamically updated in response to ongoing interaction and feedback to modify an expressive style of the generated output.

11. A system for managing persona datasets across user transitions, comprising: at least one computing device networked via a communication network; a database system storing virtual asset data including the persona datasets associated with first users of a virtual asset, the persona datasets being derived from prior interactions of the first users with the virtual asset and persisting with the virtual asset upon a transfer of the virtual asset from the first users to a second user; a persona synthesis module configured to combine, in response to the transfer of the virtual asset to the second user, prior users persona data with the second user's persona data to generate a derived persona dataset, the second user being distinct from the prior users; and a content synthesis engine configured to generate adaptive content based on the derived persona dataset.

12. The system of claim 11, wherein the derived persona dataset persists with the virtual asset upon a second transfer of the virtual asset from the second user to a third user, the third user being distinct from the second user, and wherein the persona synthesis module is further configured to generate a second derived persona dataset that preserves residual influence of the one or more first users and the second user.

13. The system of claim 11, content filtering module filters inappropriate content for the derived persona dataset.

14. The system of claim 11, wherein virtual asset data is a component of a home robot persona or a social artificial intelligence companion.

15. A method for synthesizing a persona dataset for use in an adaptive system, comprising: receiving a first persona dataset representing behavioral or expressive characteristics derived from interactions of one or more prior owners of a digital system with the digital system; receiving, in response to a transfer of the digital system from the one or more prior owners to a current owner, a second persona dataset representing behavioral or expressive characteristics of the current owner of the digital system, the current owner being distinct from the one or more prior owners; receiving a session history dataset representing interaction data from one or more prior sessions with the digital system; combining the first persona dataset and second persona dataset to create an adaptive persona dataset that persists with the digital system and preserves residual influence of the one or more prior owners; and using the adaptive persona dataset for generation of adaptive content or behavior that reflects influence of the one or more prior owner and the current owner.

16. The method of claim 15, wherein the digital system comprises at least one of a non-player character, weapon, or tool.

17. The method of claim 15, wherein the first persona dataset and the second persona dataset are combined according to a weighting function that applies asymptotic adaptation behavior, wherein the influence of the current owner increases over time but never fully replaces historical traits of prior users.

18. The method of claim 15, wherein the session history dataset enables past interaction sessions to influence subsequent sessions, creating continuity of experience across multiple sessions.

19. The method of claim 15, further comprising content filtering that preserves stylistic and linguistic influences from prior owners that are appropriate for a current context while excluding or attenuating content that conflicts with current user preferences or platform requirements.
